(19) United States
(12) Patent Application Publication
(10) Pub. No.: US 2003/0030540 A1
(43) Pub. Date: Feb. 13, 2003

(54) Method and apparatus for updating security control system operating parameters

(76) Inventor: Wayne C. Hom, Rancho Santa Margarita, CA (US)

Correspondence Address: LEVIN & HAWES, P O BOX 4140, LAGUNA BEACH, CA, 92652

(21) Appl. No.: 09/925,946

(22) Filed: Aug. 9, 2001

(51) Int. Cl. H04Q 1/00

(52) U.S. Cl. 340/5.22; 340/5.21; 340/5.2; 700/1; 379/93.02

(57) ABSTRACT

A method and apparatus are disclosed for updating the operating parameters for a security gate having a control system comprising a memory, including storing a first plurality of operating parameters in a plurality of first data locations within the memory, providing the control system with a first map to the memory indicating the respective first data location for each of the respective plurality of operating parameters; loading a plurality of operating parameters into a plurality of second data locations within the memory, the plurality of second data locations not including any of the plurality of first data locations; providing the control system with a second map to the memory indicating the respective second data location for each of the respective plurality of operating parameters; initiating a change in the control system to substitute use of the second map in place of the first map; loading a plurality of operating parameters into a plurality of third data locations within the memory, the plurality of third data locations not including any of the plurality of second data locations; providing the control system with a third map to the memory indicating the respective third data location for each of the respective plurality of operating parameters; and initiating a change in the control system to substitute use of the third map in place of the second map. The method and apparatus may also include that the third map and the first map are the same for each respective one of the plurality of operating parameters, the set of operating parameters stored in each of the first, second and third data locations being the same and/or the set of operating parameters stored in the second and third data locations is an updated value for the respective parameter from that previously stored in the respective data location.

### FIELD OF THE INVENTION

The present invention relates to the field of security gates, particularly ones controlled by a control system employing a plurality of operating parameter settings.

### BACKGROUND OF THE INVENTION

It is well known to have security gates with a control system that is responsive to a number of control settings or parameters. By way of example, the operation of the gate may be responsive to a code received by the system through any of a number of ways, e.g., a “garage-door-opener” type of optical, sound or radio transmission device that the control system is capable of receiving and which is encoded to open the security gate. Another example could be the entry of a code through a key pad, or other similar input device, located at the site of the security gate. Still a further example could be the receipt of a signal from a remote location over, e.g., the telephone lines, including the Public Switched Network or wireless, or like communication devices such as a pager-type system, etc. It is also known to have special control parameters that the security gate system is capable, ordinarily through software programming and parameter settings, to specially control. For example, specific codes or coded transmitter devices may be able to induce the control system to recognize an authorized request to activate the security gate only a certain times or certain dates/times. Therefore, for example, the system may recognize the code given to, e.g., a delivery person only on a specific date or only with a specific period of time during each day, or a combination of both. An authorization for access granted on a more random basis, e.g., by the occupant of a unit within the complex protected by the security gate in response to a party seeking access having contacted the occupant, may only remain active for a few minutes, or an hour or for some other specified period of time. Similarly, the code for a person no longer authorized access may be permanently deleted from those that the system recognizes as authorized entrants, e.g., in case the person has kept a coded entry device or retains knowledge of the entry code. Various other parameters for the operation of the security gate can also be set for control at the control system, e.g., speed, the reaction to encountering an obstacle in opening or shutting, reaction of the system to attempts to breach the gate system, by, e.g., tailgating and authorized entrant, alarm settings, reset conditions, etc. It is also known to set or upgrade these settings/parameters remotely through some form of communication network.

Problems can arise in such setting or upgrading where an attempt is made to enter or leave through the security gate while setting or resetting is in progress. These problems can include the security gate continuing to respond the an earlier and now invalid parameter during the specific entry occurring as the parameters bre being reset, or even continuing thereafter because the simultaneous operation of the control system and attempted resetting of the parameters has left unchanged the original parameter setting that was intended to be changed. Worse yet, the newly intended parameter and the previously existing parameter may neither be set during this time when the control system is both operating the security gate and attempting to process instructions for the resetting the parameter, which could in the worst case cause the gate not to fu nction at all or, equally troubling, to allow unauthorized entrance of egress.

### SUMMARY OF THE INVENTION

The present invention solves these shortcomings of the security gate control systems of the prior art. A method and apparatus are disclosed for updating the operating parameters for a security gate having a control system comprising a memory, including storing a first plurality of operating parameters in a plurality of first data locations within the memory, providing the control system with a first map to the memory indicating the respective first data location for each of the respective plurality of operating parameters; loading a plurality of operating parameters into a plurality of second data locations within the memory, the plurality of second data locations not including any of the plurality of first data locations; providing the control system with a second map to the memory indicating the respective second data location for each of the respective plurality of operating parameters; initiating a change in the control system to substitute use of the second map in place of the first map; loading a plurality of operating parameters into a plurality of third data locations within the memory, the plurality of third data locations not including any of the plurality of second data locations; providing the control system with a third map to the memory indicating the respective third data location for each of the respective plurality of operating parameters; and initiating a change in the control system to substitute use of the third map in place of the second map. The method and apparatus may also include that the third map and the first map are the same for each respective one of the plurality of operating parameters, the set of operating parameters stored in each of the first, second and third data locations being the same and/or the set of operating parameters stored in the second and third data locations is an updated value for the respective parameter from that previously stored in the respective data location.

### BRIEF DESCRIPTION OF THE DRAWINGS

FIG. 1 shows a schematic diagram of a control system for a security gate according to the present invention.

### DETAILED DESCRIPTION OF THE PREFERRED EMBODIMENTS

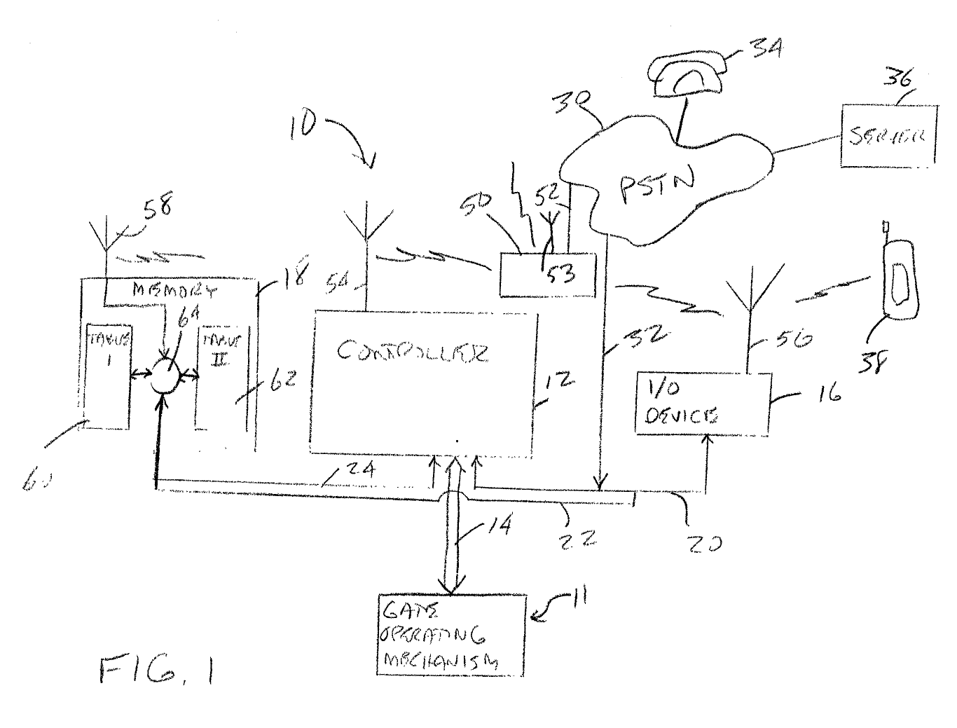

Turning now to FIG. 1 there is shown a schematic diagram for a control system 10 for a security gate operating mechanism 11 according to an embodiment of the present invention. The system 10 may include a security gate operating mechanism controller 12. The security gate operating mechani9sm controller 12 can be connected to the security gate operating mechanism 11 by an information transfer bus. The gate operating mechanism may include a drive motor and various sensors connected directly or indirectly to the drive motor or the gate itself, to sense such things as position and movement of the gate, motor operating temperature, speed, etc., inertial force on the gate, etc. The information transfer bus may transfer from the security gate operating mechanism and or from the sensors connected directly or indirectly to the gate operating mechanism information to the controller 12. The information transfer bus 14 may transfer from the controller information/commands, such as commands to start/stop the drive motor, increase/decrease the drive motor speed, increase/decrease cooling fluid supply to the drive motor, etc., which are generated by the controller 12 in response to the information received from the gate operating mechanism and/or associated sensors, and in accordance with preselected and programmed control algorithms. It will be understood that the controller 12 and gate operating mechanism 11 may be a part of the same unit, e.g., located on the same printed circuit board (not shown) or in the same gate controller housing (not shown) or they could be remote from each other, e.g., with the gate operating mechanism at the location of the gate and the controller 12 and other equipment associated with the controller function in a remote centralized unit controlling the operation of the one or many gates, and/or in a remote building, etc. It will also be understood that the remote gate operating mechanism 11 may also have a controller function built into it, e.g., in the form of a mircoprocessor on the board at the gate operating mechanism 11 which can assume the functions set forth herein for the controller 12 or some subset of them, leaving the remainder to the controller 12.

The controller 12 may also be in communication with an input/output device 16. The input output device 16, shown here schematically and generically will also be understood to have a number of possible implementations. The I/O device may be a full or truncated computer keyboard I/O. It may be positioned at the security gate in or near the unit housing the gate operating mechanism or remotely with the controller 12, or a combination of these possible locations. The I/O device 16 can serve to update the controller 12 as to operating parameters that he security gate is to operate within, e.g., speed of movement, location of a first open and a second shut position, hereinafter referenced as operating parameter information. In addition, the I/O device 16 may serve to input or modify/update other information, e.g., access information, which may include, e.g., the identity of certain vehicles, individuals, company vehicles, etc. that are authorized entry, and/or codes or other identifying information, e.g., garage-door opener style devices that can communicate with the I/O device 16, as is well known, e.g., in ultrasound, radio, infrared, or the like, or which can be input through the I/O device 16, I the form of a name, or a personal identification number (“PIN”) or other code and/or a combination of these to indicate authorized access. In addition, the controller 12 and gate operating mechanism 11 may be responsive to certain identified authorized entrants only on certain days of the week, or a particular single date or dates, or within certain range of times on any given date, or any combination of these factors, e.g., to allow a unique delivery of an item to a resident in a complex protected by the security gate on a certain date between certain hours, but not otherwise, or a routine entry of some scheduled delivery or pick-up service, e.g., laundry or dry cleaning, or some scheduled arrival of a cleaning service, etc.

A memory 18, which may be a part of the controller 12, and/or of the controller 12 and gate operating mechanism 11, i.e., contained within the same housing as either or both of them, depending upon the configuration of the controller 12 and operating mechanism 11 from the possible configurations noted above. The memory 18 may be communicated to directly through the I/O device 16, or through the controller 12, either directly or indirectly from the I/O device 16, or through some other communication channel, e.g., an antenna 58, which will be understood to be generic to communication from other than the controller 12 and/or I/O device 16, e.g., over a telephone line, cable connection or otherwise. Likewise, the entire system 10 can be accessed and controlled and/or have its operating or access parameters input, updated or modified through a communication system as is well known in the art and which includes at least the elements noted in FIG. 1.

The communication/control system can include a public switched telephone network (“PSTN”) 30, which as is well known in the art can be accessed through, e.g., a telephone handset 34, a remote server computer 36, a wireless telephone, pager, palm pilot, personal digital assistant or the like. Wireless connection to the PSTN may be direct or indirect through, e.g. a wireless central station 50. The wireless central station may be connected to the PSTN 30 through a line 52 or an antenna 53. Other antennae 54, 56 and 58 may allow wireless communication from or through the PSTN to respectively the controller 12, I/O device 16 and/or memory 18, or may, alternatively allow direct wireless communication between the Controller 12, I/O device 16 and memory 18. It will be understood that the information transfer bus 14 may be wireless as well.

With all of the possible communication links to the memory 18 to input, update and modify the various parameters stored therein the opportunity exists for several types of unintended and/or inadvertent failures of the security gate operating mechanism to appropriately respond to the existing circumstances and either fail to open when required or open when not appropriately authorized to open, as examples. This can occur if the gate operating mechanism 11 receives a signal indicating, e.g., that access is demanded. This can be, e.g., through the sensing of a vehicle in an access position by, e.g., a magnetic sensor, or a push button or the receipt of an ultrasound, radio or infrared access signal, before the access parameters are input into the memory 18 and/or while they are being input or updated or modified. In this even, the system may be triggered to respond to a set of stored parameters that are not complete, or that are in the process of being changed. In such an event there are several inappropriate responses that can occur. For example the system may fail to respond at all, denying access where access should be allowed or respond to outdated parameters, e.g., allowing access where access should be denied.

According to the present invention, the memory 18 can be divided into at least two parameter sections 60 and 62, labeled, e.g., Table I and Table II. A means, such as a switch 64 can be used, e.g., to control the entry of parameter information into the respective Table I 60 and Table II 62, and access to each respective Table I 60 and Table II 62, such that unless all of the parameters contained in the memory Table I are stored in the memory Table I 60 or Table II 62, respectively, that portion of the memory cannot be accessed for control purposes. This may be done, e.g., through the use of software and stored flags for each entry, which if not present indicate that the data is not yet stored in the associated data entry location or, similarly with logic circuitry that indicated that each of a plurality of stored memory locations have been filled. Once all of the flags are set, or there is otherwise given an indication of the parameter locations being filled then the memory location, e.g., Table I 60 or Table II 62 may be made available for access to provide information for the controller 12 and/or gate operating mechanism 11 to utilize in processing access requests, as noted above.

The other table of the Table I 60 and Table II 62 may then be loaded with duplicate information and, e.g., act as a backup in the event that something such as a power surge or the like causes the other table to contain invalid information. By way of example, check-sums may be periodically tested to verify that the currently used one of Table I and Table II remains valid, and/or other forms of checking, such as verification of the formats or the like in which particular parameters are stored are valid, can be used upon some or all parameters periodically. More likely, however, the other of the Table I 60 and Table II 62 not in operation will be subject to being updated or modified, and then substituted for the respective other Table I 60 or Table II 62. In this manner, the update or modification to the respective Table I 60 and Table II 62 that is not currently in use as the source of the operating or access parameters can be updated and validated, e.g. to insure that conflicting sources of the communication of updated or modified parameters have not concurrently sought to update the respective Table I 60 or Table II 64, causing invalidation of some parameters while other may be those desired. In this manner, e.g., if a remote server 36 is attempting to update parameters at the same time a s, e.g., a technician at the I/O device 16, the system will only allow the updated one of the Table I 60 or Table II 62 to become the operating table if all of the inputs from the one source are present in the table and not a mixture of parameters from two or more sources. This may be done, e.g., by utilizing coded flags that identify the source of a modification and only allowing a Table I 60 or Table II 62 to be substituted if all data entries in the respective Table I 60 or Table II 62 have not only a flag, but the same flag. It will also be understood that some or all of the data entries may be nulls, e.g., being defaulted to nulls, unless expressly updated or modified, or may be defaulted to remain as in the one of the Table I 60 or Table II 62 that is on line, unless expressly modified by the source of th3e update or modification.

In this manner, before the currently used one of the Table I 60 or Table II 62 is removed from operation as the source of parameter information for the operation of the security gate the other of the Table I 60 or Table II 62 is established as a newly created, complete and verified table created and ready to be substituted for the one of the Table I 60 or Table II 62 that is currently on line. By way of example, a software pointer may be set to indicate that the one or the other of Table I and Table II is the active table, and resetting that pointer to the other of the Table I or Table II once it is ready for substitution may be used to substitute the one of the Table I and Table II to which the new pointer points.

It will be understood by those in the art that the switch 64 may be implemented in software or hardware or a combination of both. By way of example, the controller 12 or gate operating mechanism 11 or remote access from, e.g., server 36, or whatever part of the system 10 is seeking to update the parameter being used by the system 10 may be enabled, through software or logic circuitry represented by switch 64, to scan the address locations in memory 18 comprising Table I, where Table II is the Table currently in use, to see if all of the appropriate flags are set, or otherwise to indicate that Table I is complete and verified as noted above. In this event, the controller12, or gate operating mechanism or a combination of both can then be made to select Table I as the appropriate table containing the most updated parameters. It will also be understood that Table I and Table II may comprise additional tables or subsections of tables, e.g., to separately update and/or modify, e.g., operating parameters and access parameters and/or to update and/or modify either or both of these, but particularly access parameters on the basis of individual subscribers, e.g., residents within a gated complex, who may wish individually to update access parameters. It will be understood that when only a portion of the one of Table I and Table II that is being updated is to be updated or modified, then the system may require that all of the flags in the entire table be updated to indicate that the entire one of the Table I or Table II is ready for use, or may only require that the table or sub-table being updated is given new flags. Thus the system 10 may be given an indication that the other of the Table I or Table II is ready for use by having all of its flags set to a particular flag, which may be the same as or different from the flag indicating that the one of the Table I and Table II currently in use is valid for use, or the other of the Table I and Table II, if formed of multiple tables and/or sub-tables may have all of the flags throughout the entire Table I or Table II set to a particular flag, or may have the multiple tables and/or sub-tables have distinct flags that each must be set to in order to indicate the entire one of the Table I or Table II is valid and ready for use. In any event, the system will be programmed to only switch to another of the Table I or Table II which is not currently in use when the indication is given that the entire another of the Table I or Table II has been updated or modified. In another aspect of the present invention, the figurative hardware/software switch 64 may be used to insure that different input sources are not able to update/modify the one of the Table I or Table II or its constituent or sub-tables, at the same time. This can be accomplished, e.g., by some form of input/output bus control exercised by the controller 12, I/O device 16 and/or the memory 18 itself, and may be instigated remotely from the input devices, e.g., telephone 34, server 36 or wireless input device 38. This may be accomplished through, e.g., coded inputs, which the bus control system can screen for the appropriate input device, 3.g., 34, 36, 38 or 16. It may also be implemented by unique flags associated with the updating from a particular input. In this manner, the system 10 can be assured that the inputs to update or modify parameters in the memory 18, i.e., in the one of the Table I or Table II that is not currently on line, are all received in a given time period from one possible input device, and if a conflict somehow occurs such that inputs received from different input devices contemporaneously to the same table or sub-table the system will not recognize the update or modification as valid and will not allow switching to the non-valid table or sub-table.

The present invention has been described in regard to a presently preferred embodiment of the invention but should not be limited only to this preferred embodiment. Other modification and changes to the concept of the presenting invention as embodied in the presently preferred embodiment will be understood by those skilled in the art to be possible. By way of example only, the controller 12, I/O device 16, and memory 18, or all of these and the gate operating mechanism 11 can be incorporated into a single unit, mounted, e.g., on or with the mechanical operating mechanism for the security gate. Some portions or all of these portions of the system 10 may be implemented in a single or multiple chip integrated circuit device. A separate bus control/ memory access manager unit may be included and function as switch 64 or along with some other logic circuitry and/or software comprising switch 64. These and other modifications will be understood to be part of the present invention and included within the literal language of the claims and/or equivalents of elements of the claims.

We claim:

1. A method for updating the operating parameters for a security gate having a control system comprising a memory, including the steps of:
storing a first plurality of operating parameters in a plurality of first data locations within the memory,
providing the control system with a first map to the memory indicating the respective first data location for each of the respective plurality of operating parameters;
loading a plurality of operating parameters into a plurality of second data locations within the memory, the plurality of second data locations not including any of the plurality of first data locations;
providing the control system with a second map to the memory indicating the respective second data location for each of the respective plurality of operating parameters;
initiating a change in the control system to substitute use of the second map in place of the first map;
loading a plurality of operating parameters into a plurality of third data locations within the memory, the plurality of third data locations not including any of the plurality of second data locations;
providing the control system with a third map to the memory indicating the respective third data location for each of the respective plurality of operating parameters; and
initiating a change in the control system to substitute use of the third map in place of the second map.

2. The method of claim 1 wherein the third map and the first map are the same for each respective one of the plurality of operating parameters.

3. The method of claim 1 wherein the set of operating parameters stored in each of the first, second and third data locations are the same.

4. The method of claim 2 wherein the set of operating parameters stored in each of the first, second and third data locations are the same.

5. The method of claim 1 wherein at least one of the set of operating parameters stored in the second and third data locations is an updated value for the respective parameter from that previously stored in the respective data location.

6. The method of claim 2 wherein at least one of the set of operating parameters stored in the second and third data locations is an updated value for the respective parameter from that previously stored in the respective data location.

7. The method of claim 3 wherein at least one of the set of operating parameters stored in the second and third data locations is an updated value for the respective parameter from that previously stored in the respective data location.

8. The method of claim 4 wherein at least one of the set of operating parameters stored in the second and third data locations is an updated value for the respective parameter from that previously stored in the respective data location.

9. The method of claim 1 wherein the steps of loading are carried out from a remote location in communication with the control system through a communication network.

10. The method of claim 2 wherein the steps of loading are carried out from a remote location in communication with the control system through a communication network.

11. The method of claim 3 wherein the steps of loading are carried out from a remote location in communication with the control system through a communication network.

12. The method of claim 4 wherein the steps of loading are carried out from a remote location in communication with the control system through a communication network.

13. The method of claim S wherein the steps of loading are carried out from a remote location in communication with the control system through a communication network.

14. The method of claim 6 wherein the steps of loading are carried out from a remote location in communication with the control system through a communication network.

15. The method of claim 7 wherein the steps of loading are carried out from a remote location in communication with the control system through a communication network.

16. The method of claim 8 wherein the steps of loading are carried out from a remote location in communication with the control system through a communication network.

17. The method of claim 1 wherein all of the operating parameters in the set of operating parameters stored in the second data locations has the same value as was stored in the respective first data locations and the initiation of the change in the control system is in response to an indication that at least one of the values stored in a respective first data location has been corrupted.

18. The method of claim 2 wherein all of the operating parameters in the set of operating parameters stored in the second data locations has the same value as was stored in the respective first data locations and the initiation of the change in the control system is in response to an indication that at least one of the values stored in a respective first data location has been corrupted.

19. The method of claim 3 wherein all of the operating parameters in the set of operating parameters stored in the second data locations has the same value as was stored in the respective first data locations and the initiation of the change in the control system is in response to an indication that at least one of the values stored in a respective first data location has been corrupted.

20. The method of claim 4 wherein all of the operating parameters in the set of operating parameters stored in the second data locations has the same value as was stored in the respective first data locations and the initiation of the change in the control system is in response to an indication that at least one of the values stored in a respective first data location has been corrupted.

21. An apparatus for updating the operating parameters for a security gate having a control system comprising a memory, comprising:
storage means for storing a first plurality of operating parameters in a plurality of first data locations within the memory,
a control system having a first mapping means for indicating the respective first data location for each of the respective plurality of operating parameters within the memory;
storage means for storing a plurality of operating parameters into a plurality of second data locations within the memory, the plurality of second data locations not including any of the plurality of first data locations;
the control system having a second mapping means for indicating the respective second data location for each of the respective plurality of operating parameters;
switching means for switching the control system from the first mapping means to the second mapping means;
storage means for storing a plurality of operating parameters into a plurality of third data locations within the memory, the plurality of third data locations not including any of the plurality of second data locations;
switching means for switching the control system from the second mapping means to the third mapping means.

22. The apparatus of claim 21 wherein the third mapping means and the first mapping indicate the same respective data location for each respective one of the plurality of operating parameters.

23. The apparatus of claim 21 wherein the set of operating parameters stored in each of the first, second and third data locations are the same.

24. The apparatus of claim 22 wherein the set of operating parameters stored in each of the first, second and third data locations are the same.
